(19) United States
(12) Patent Application Publication
(10) Pub. No.: US 2004/0211353 A1
(43) Pub. Date: Oct. 28, 2004

(54) Pressure monitoring system for use with an air tool

(76) Inventors: Bobby Lynn Lawrence, Lawrenceburg, IN (US); Gregory Allen Kramer, Fairfield, OH (US); Daniel Edward Preston, Milford, OH (US)

Correspondence Address: Michael R. Asam, Jones Day, 901 Lakeside Avenue, Cleveland, OH, 44114, US

(21) Appl. No.: 10/422,569

(22) Filed: Apr. 24, 2003

(51) Int. Cl. G01L 19/12

(52) U.S. Cl. 116/272

(57) ABSTRACT

The present invention relates to an air pressure monitoring system for monitoring the air pressure being supplied to an air tool during use. The air pressure monitoring system of the present invention provides a binary indication of whether the air pressure within an operating tool is inside a pre-determined pressure range or outside the pre-determined pressure range utilizing a mechanical pressure gauge. The invention also concerns a continuous flow air tool that incorporates an air pressure monitoring system.

### FIELD OF THE INVENTION

This invention relates to a system for monitoring the air pressure being supplied to an air tool during use.

### BACKGROUND

Once the province of automobile repair garages and industry shops, the population of air tool users has expanded greatly in recent years. This expansion is mainly due to the availability of portable, inexpensive air compressor units. For example, a carpenter can transport a small air compressor unit to a job site for his personal use then take it home at the end of the day. Today even a homeowner can purchase an inexpensive air compressor unit for use in home repair and maintenance jobs.

A compressor unit has two main components: a compressor pump and a reservoir tank. The compressor pump pumps air into the reservoir tank. The compressor pumps typically used on portable compressor units do not pump a large enough volume of air to directly run a tool. Instead, the compressor pump charges the reservoir tank and the air from the reservoir is what is used to run the tool. When the air pressure of the reservoir tank is too low to run a tool, the user must wait for the compressor pump to replenish the reservoir tank. The size of a reservoir tank determines how long a certain pressure level can be maintained before the compressor pump must replenish the tank. Generally, the more portable a compressor unit is made, the smaller its reservoir tank will be. Thus, a user of an ultra-portable compressor unit may spend more time waiting for the compressor to charge its reservoir tank than a user with a compressor unit with a larger reservoir tank.

Today's air tools can be broken into two broad categories: intermittent operation air tools and continuous operation air tools. Intermittent operation air tools use a single burst of air to perform a single operation and then must reset before the tool can be used again. An example of an intermittent operation air tool is a nail gun, which uses a burst of compressed air to drive a piston, which in turn drives a nail. Continuous operation air tools require air continually as they are used. An example of a continuous operation air tool is a drill, which must rotate a drill bit continuously while in use. The use of both intermittent and continuous operation tools gradually depletes the store of air in the compressor unit's reservoir tank.

When the pressure level in the reservoir tank is depleted to a certain predetermined level the compressor pump turns on to replenish the air supply. However, if a continuous operation air tool continues to run, or an intermittent operation air tool is operated repeatedly after the compressor pump turns on, the pressure will be depleted faster than the compressor pump can replenish. At some decreased level of pressure, the air tools will no longer work as intended. The mechanisms that drive these air tools are designed to operate within a specific range of pressures. Operation of an air tool at air pressures outside the pressure range it was designed to use can result in poor tool performance, damage to the tool, or both.

### SUMMARY OF THE INVENTION

The claimed invention is an air pressure monitoring system for a continuous flow air tool. The air pressure monitoring system comprises a mechanical air pressure gauge coupled to a binary indicator. When coupled to a mechanical air pressure gauge in an appropriate manner, the binary indicator provides a visual indication of whether the air pressure within the tool is within an acceptable pressure range or the air pressure within the tool is not within the acceptable pressure range. An embodiment of the present invention is a continuous flow air tool with an integrated air pressure monitoring system. Another embodiment of the present invention is an air pressure monitoring system for attaching in series between the inlet of a continuous flow air tool and an air supply hose. The mechanical air pressure gauge and binary indicator are configured to couple between a continuous flow air tool and an air supply hose.

### BRIEF DESCRIPTION OF THE DRAWING FIGURES

FIG. 1 is a perspective view of a first embodiment of an air powered drill with an integrated air pressure monitoring system.

FIG. 2 is an expanded view of the handle of the air drill shown in FIG. 1.

FIG. 3 is an expanded view of an air drill handle, similar to the one shown in FIG. 1, with a second embodiment of the integrated air pressure monitoring system incorporating a fixed binary indicator.

FIG. 4 is a cross-sectional view of a mechanical air pressure gauge.

FIG. 5 is a perspective view of yet another embodiment of the air pressure monitoring system for attaching in series between an air supply and an air tool.

### DETAILED DESCRIPTION

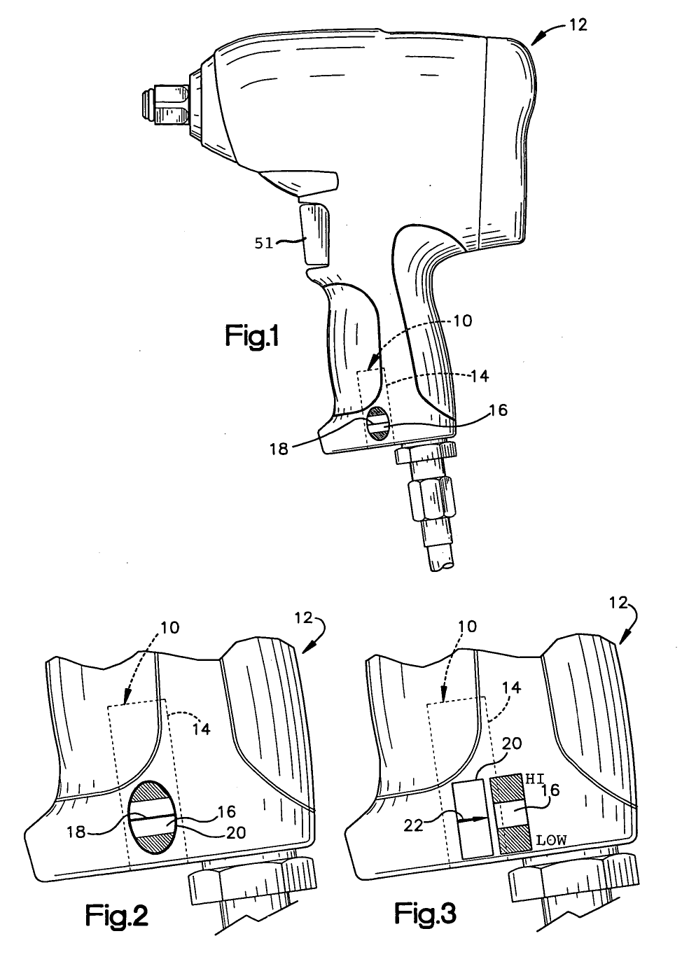

An embodiment of the air pressure monitoring system 10 of the invention integrated into the handle of a continuous flow air tool 12 is shown in FIG. 1. The air pressure monitoring system consists of several parts that are examples of the elements recited in the claims. These parts include a mechanical air pressure gauge 14 housed within the handle of the continuous flow air tool 12, a binary indicator 16, and a fixed reference point 18. FIG. 2 shows an expanded view of the handle portion of the continuous flow air tool 12 shown in FIG. 1. In the operation of this embodiment, the binary indicator 16 is coupled to the mechanical air pressure gauge 14 and is visible through an opening 20 in the housing of the continuous flow air tool 12. When compared to the fixed reference point 18, the binary indicator 16 provides a visual indication of whether the air pressure flowing through the air tool 12 during operation is within an acceptable pressure range (e.g., the open region of the binary indicator displayed in the window) or outside the acceptable pressure range (e.g., the hatched regions of the binary indicator displayed in the window). Thus, in operation, the air pressure monitoring system indicates whether the pressure of the air flowing through the tool is within an acceptable pressure range for proper tool operation.

The binary indicator 16 of the air pressure monitoring system 10 provides a visual indication of whether the air pressure being provided to the tool during operation is within an acceptable pressure range. The term “binary” as used herein means involving a choice or condition of two or more alternatives, e.g., on-off or yes-no. The primary function of the binary indicator is to indicate whether the air pressure is within an acceptable pressure range or outside the acceptable pressure range. However, the binary indicator may be configured to provide information in addition to whether the air pressure is within an acceptable pressure range or outside the acceptable range, e.g., whether the pressure is above or below the acceptable pressure range. Two possibilities exist for the air pressure monitoring system to provide information via a binary indicator 16. First, the binary indicator 16 may be moved by the mechanical air pressure gauge 14 and a fixed reference point 18 may be established in order to interpret the information provided by the air pressure monitoring system 10. In an example of this embodiment, as shown in FIG. 2, the gauge 14 has indicators, which are utilized to indicate when pressure is within an acceptable range. For example, different cross-hatching or colors, among other indicia, may be utilized on the gauge such that the gauge moves up or down relative to the fixed indicator 18, as will be discussed in greater detail below. Second, the binary indicator 16 may be fixed, i.e., stationary, and the mechanical air pressure gauge 14 may move a reference indicator 22 in relation to the binary indicator 16 in order to interpret the information provided by the air pressure monitoring system 10, as shown in FIG. 3.

The air pressure measured by the air pressure monitoring system 10 is either within an acceptable pressure range or outside the acceptable pressure range. The acceptable pressure range is established by the manufacturer of the tool and indicates the correct operating pressure range for the tool. In the air pressure monitoring system 10 of the present invention, information as to whether the current pressure is within the acceptable pressure range for operation of the tool is provided by the binary indicator 16. If the pressure is within the acceptable pressure range, a fixed reference indicator 18 or movable indicator 22 will overlap with the binary indicator 16 within the region indicating the acceptable pressure range, as shown in FIGS. 2 and 3. As discussed above, information may be provided in any visual form. Colors may be used to indicate whether the air pressure is within the acceptable pressure range. A first color may indicate air pressure within an acceptable range and a second color may indicate air pressure outside the acceptable range. The color indicating that the air pressure is within an acceptable pressure range, i.e., the first color, may be, but is not limited to, green. And the color indicating that the air pressure is not within an acceptable range, i.e., the second color, may be, but is not limited to, red. More than two colors may be used.

Indicia by itself or in combination with colors as just described may be used to indicate whether an air pressure is within an acceptable range or that the air pressure is not within the acceptable pressure range. Indicia may further indicate that the air pressure is above the acceptable pressure range or below the acceptable pressure range. Indicia indicating that the air pressure is within an acceptable range may include, but are not limited to, the words, letters, and symbols “ok”, “y”, “yes”, “in”, “inside”, “go”, “+”, and “=”. Indicia indicating that the air pressure is outside an acceptable pressure range may include, but are not limited to, the words, letters, and symbols “n”, “no”, “out”, “outside”, “no-go”, “stop”, “−”, “≠”, and “×”. Indicia indicating that the air pressure is above an acceptable pressure range may include, but are not limited to, the words and symbols “hi”, “high”, “over”, “above”, “Λ”, “↑”, and “▴”. Indicia indicating that the air pressure is below an acceptable pressure range may include, but are not limited to, the words and symbols “lo”, “low”, “under”, “below”, “v”, “↓”, and “▾”.

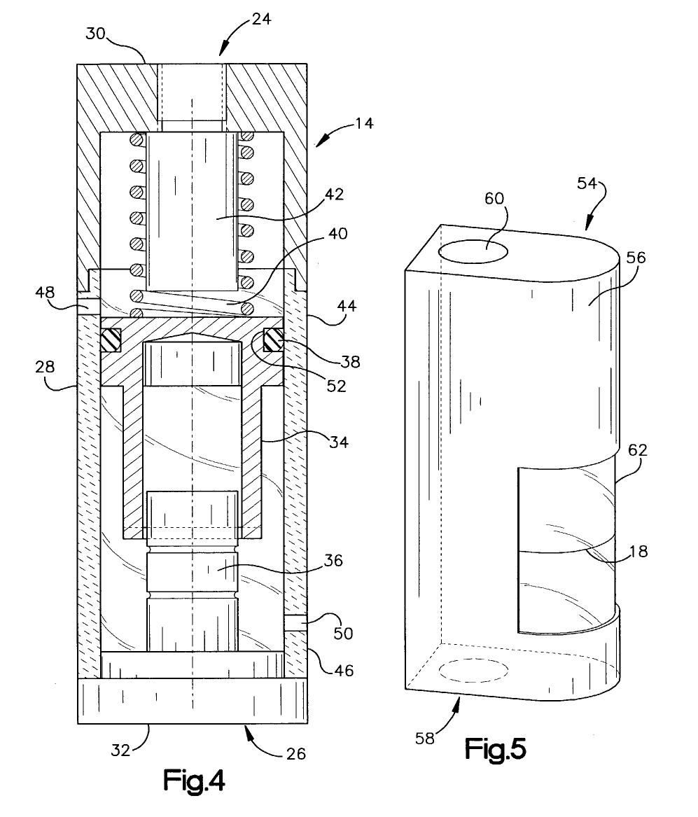

The types of mechanical air pressure gauges 14 useful for this invention will be readily apparent to those of skill in the art and can be any type of mechanical air pressure gauge capable of coupling with a binary indicator 16 of the type described above. The term “gauge” as used herein means an instrument for measuring. The term “mechanical” as used herein means caused by, resulting from, or relating to a process that involves a physical as opposed to a chemical or electrical change. An example of a mechanical air pressure gauge 14 useful in this invention is shown in FIG. 4. FIG. 4 depicts a mechanical air pressure gauge 14 having a top 24 and a bottom 26 that is composed of several parts. These parts include a housing 28, a top plug 30, a bottom plug 32, a piston 34, a piston guide 36, an o-ring 38, a compression spring 40, and a piston stop 42. The housing has a top 44 and a bottom 46. The housing 28 is tubular and may be made of a transparent material, including but not limited to, acrylic or polycarbonate, or may be made of an opaque material and include a transparent portion. An external pressure vent 48 is cut into the housing toward the top 44 and an internal pressure port 50 is cut into the housing toward the bottom 46.

The top plug 30 is cylindrical with a solid top, a hollow interior, and an open bottom. The top plug 30 is fitted onto the top of the housing 44 such that the connection to the housing is made at the bottom of the top plug 30 and the hollow interior portion of the top plug is open to the interior of the housing 28. The bottom of the top plug 30 can be adapted to easily connect with the top of the housing 44. The connection between the top plug 30 and the housing 28 forms a seal. The top plug 30 may be made of any suitable material, including but not limited to, aluminum, brass, and plastic.

The bottom plug 32 is a solid cylindrical segment with a top and a bottom. The bottom plug 32 is fitted into the bottom of the housing 46 such that the connection is made at the top of the bottom plug 32. The top of the bottom plug 32 can be adapted to easily connect with the bottom of the housing 46. The connection between the bottom plug 32 and the housing 28 forms a seal. The bottom plug 32 may be made of any suitable material, including but not limited to, aluminum, brass, and plastic.

The piston guide 36 is smooth and cylindrical. The piston guide 36 is attached to and extends from the bottom plug 32 into the housing 28. The diameter of the piston guide 36 is smaller than the inner diameter of the housing 28. The piston guide 36 may be made of any suitable material, including but not limited to, aluminum, brass, and plastic. The piston guide 36 may be an integral part of the bottom plug 32 that is formed when the bottom plug 32 is formed or it may be a separate part attached to the bottom plug 32 by any suitable method including, but not limited to, threading a bottom portion of the piston guide 36 and threading it into a threaded hole in the bottom plug 32.

The piston stop 42 is cylindrical. The piston stop 42 is attached to and extends from the top plug 30 into the housing 28. The diameter of the piston stop 42 is smaller than the inner diameter of the housing 28. The piston stop 42 may be made of any suitable material, including but not limited to, aluminum, brass, and plastic. The piston stop 42 may be an integral part of the top plug 30 that is formed when the top plug 30 is formed or it may be a separate part attached to the top plug 30 by any suitable method including, but not limited to, threading a portion of the piston stop 42 and threading it into a threaded hole in the top plug 30.

The piston 34 has a cylindrical top portion and a bottom portion. The piston 34 may be made of any suitable material including, but not limited to, aluminum, brass, and plastic. The upper surface of the cylindrical top portion of the piston 34 is solid. An o-ring 38 is positioned in a groove 52 in the outer surface of the top portion of the piston 34 near the upper surface of the piston 34. The size of the groove 52 housing the o-ring 38 is chosen so that a portion of the o-ring 38 extends from the groove 52. 0-rings useful for this invention will be easily recognized by those of skill in the art and are commercially available. The diameter of the cylindrical top portion of the piston 34 is smaller than the internal diameter of the housing 28. The diameter of the cylindrical top portion of the piston 34 is large enough that the portion of the o-ring 38 extending from the groove 52 forms a compression seal between the piston 34 and the housing 28 when the piston 34 is inserted into the housing 28.

In operation, the piston 34 moves axially within the housing 28 and the outer diameter of the piston 34. The size of the groove 52 and the o-ring 38 are selected to form a compression seal between the piston 34 and the housing 28 that is maintained when the piston 34 moves within the housing 28. Alternatives to o-rings that would satisfactorily form a seal between the piston and the housing and maintain that seal if the piston moves could also be used. The bottom portion of the piston 34 interacts with the piston guide 36 to allow the piston 34 to move axially within the housing 28 while maintaining a uniform orientation. The bottom portion of the piston 34 may be any form capable of interacting with the piston guide 36 to allow the piston 34 to move axially within the housing 28 while maintaining a uniform orientation. The bottom portion of the piston 34 may be a tube attached to the cylindrical top portion by a suitable method with a large enough inner diameter to fit over the piston guide 36 or it may be an integral part of the cylindrical top portion of the piston 34 that is formed when the cylindrical top portion is formed. If the bottom portion of the piston 34 is a tube, portions of the tube wall may be removed as long as the ability of the bottom portion to maintain the orientation of the piston 34 is not compromised. The range of motion of the piston 34 is from a contracted position where the piston 34 is located as far as it will travel onto the piston guide 36 to an extended position where the surface of the cylindrical top portion of the piston 34 makes contact with the piston stop 42. The internal pressure port 50 and the external pressure vent 48 that are cut into the housing 28 are respectively located below the o-ring 38 position of the fully contracted piston 34 and above the o-ring 38 position of the fully extended piston 34.

The compression spring 40 fits over the piston stop 42 and extends into the housing 28 toward the piston 34. Compression springs with acceptable parameters for use with this invention (i.e., spring rate, maximum load, maximum stress, solid height, coil pitch, coil angle, wire length, resonant frequency, shear modulus, and spring mass) are commercially available from sources known to those of skill in the art. The proper operating pressure range for a tool will influence the compression spring that is chosen for a particular application. Preferably a compression spring having an unloaded length that is approximately equal to the distance between the inner surface of the top plug and the top surface of the piston when the piston is in its fully contracted position is used.

In operation, the mechanical air pressure gauge 14 spans a barrier between two distinct pressure regions, an external pressure region and an internal pressure region, such that the two regions are isolated. In this configuration, the external pressure vent 48 of the mechanical air pressure gauge is exposed to a first, external pressure region and the internal pressure port 50 is exposed to a second, internal pressure region, as will be described in greater detail below. The o-ring 38, which maintains a seal between the piston 34 and the housing 28 when the piston 34 moves, forms an adjustable boundary between the two differential pressure regions. The pressures of the two regions may be equal. When the pressures of the two regions are equal, the only potential force acting on the piston 34 is residual spring compression from the compression spring 40. When the pressure of the internal region is greater than the pressure of the external region, the piston 34 will be forced against the compression spring 40. And when the force exerted on the piston by the pressure differential equals the force exerted by the spring on the piston, the position of the piston 34 will stabilize.

A binary indicator may be coupled in a variety of ways to the mechanical pressure gauge as just described. When a binary indicator 16 is attached to and allowed to move freely with the piston 34 of the mechanical pressure gauge, a fixed reference may be established. The binary indicator 16 moves relative to the fixed indicator 18 to allow the pressure information provided by the binary indicator 16 to be interpreted, as shown in FIGS. 1 and 2 by fixed reference line 18. As an alternative, the binary indicator 16 may be in a fixed location, i.e. stationary, and a movable indicator 22 attached to or part of the piston 34 may move relative to the fixed binary indicator 16 to provide the same pressure information, as shown in FIG. 3.

As will be readily apparent to one of ordinary skill in the art, a large range of pressure differentials may be measured by using compression springs with different parameters in combination with a binary indicator. Further, the combination of compression springs with different compression values and different binary indictors with various color and indicia combinations provides a large array of potential pressure range indicators.

An air pressure monitoring system of the present invention may be inserted into the housing of a continuous flow air tool 12, as shown in FIGS. 1-3. The types of mechanical air pressure gauges useful for inclusion into the housing of a continuous flow air tool 12 will be readily apparent to those of skill in the art and can be any type of mechanical air pressure gauge 14 capable of coupling with a binary indicator 16 of the type described above. The mechanical air pressure gauge 14 as just described may be inserted into the housing of a continuous flow air tool 12. When inserted into the housing of a continuous flow air tool 12, the external pressure vent 48 of the mechanical air pressure gauge 14 must be connected to the exterior of the tool and the internal pressure port 50 must be connected to an air passage within the tool through which air flows to power the tool. The internal pressure port 50 may be connected downstream from the air tool's air flow control mechanism to a passage directly connected to an air hose that is in turn connected to an air compressor reservoir tank. Alternatively the internal pressure port may be connected to a passage upstream from the air tool's air flow control mechanism. A connection on either side of the air flow control mechanism will enable the air pressure monitoring system to provide the same pressure information while the tool is operating. As used herein, an air tool's air flow control mechanism is the mechanism that allows the user to control the flow of air to the tool, which may include, but is not limited to, a trigger and valve combination that responds to finger pressure by the air tool user. And, downstream and upstream are intended to mean before and after the air tool's air flow control mechanism respectively.

If the binary indicator 16 is to be attached to the piston 34 of the mechanical air pressure gauge 14, as shown in FIGS. 1 and 2, the means of attachment and the position of attachment may be determined by the orientation of a view port 20 in the tool housing. The view port 20 in the tool housing should be large enough that the binary indicator 16 can be easily seen, but can be positioned at any number of different positions. As the binary indicator 16 itself moves when attached to the piston 34, the view port 20 in the tool housing will contain a fixed reference 18 against which the position of the binary indicator 16 may be compared. As an alternative to a line as a fixed reference, the view port 20 itself may act as a reference because its location is fixed. For example, the compression spring 40 and configuration of the binary indicator 16 could be chosen such that if any of a certain color were visible in the view port 20 the user would know that the operating pressure is within a safe operation range. If the binary indicator 16 is to be fixed to the air tool housing, as shown in FIG. 3, an indicator 22 attached to or part of the piston 34 could be positioned so that it is visible within the view port 20 and moves relative to the fixed binary indicator 16 to provide the same pressure information.

The intention of the air pressure monitoring system 10 of the present invention is to monitor the dynamic air pressure while air is flowing through a tool during use. However, the air pressure monitoring system 10 will also monitor static air pressure while the tool is not in use. Depending on the configuration of the air pressure monitoring system 10, different pressures may be displayed while the tool is not in use. If the air pressure monitoring system 10 is configured to sample the air pressure before the valve controlled by the trigger or actuating device, the static pressure provided to the tool from the compressor's reservoir tank will be monitored. In this configuration, the air pressure monitoring system 10 may indicate whether the compressor reservoir tank is empty or does not have enough pressure to operate the tool. If the air pressure monitoring system 10 is configured to sample the air pressure after the tool actuating device, the air pressure monitoring system 10 will only monitor atmospheric pressure when the air tool is not operating. When the tool is not in use, neither configuration provides information about what the dynamic pressure will be once the tool is in operation. However, both configurations will allow useful measurements of the pressure of the air flowing through the tool during use.

In another embodiment of the invention, an air pressure monitoring system is provided that can be attached in series between the inlet of a continuous flow air tool and an air supply hose. The binary indicator used in this embodiment is the same as that described above. The types of mechanical air pressure gauges useful for this embodiment of the invention will be readily apparent to those of skill in the art and can be any type of mechanical air pressure gauge capable of coupling with a binary indicator 16 of the type described above. The mechanical air pressure gauge may be the same as the example mechanical air pressure gauge 14 described above. Instead of being inserted into the housing of a continuous flow air tool 12, the air pressure monitoring system 54 of this embodiment is contained in a separate housing 56, as shown by way of the example in FIG. 5. The operating principles of the air pressure monitoring system 54 of this embodiment are the same as that described above.

As indicated by FIG. 5, the air pressure monitoring system 54 of this embodiment has ports for air entry 58 and exit 60. The air entry 58 and exit 60 ports are connected within the body of the housing 56 by an air passage. The air entry port 58 may be designed to accept standard or specialized fittings and may be connected by standard or specialized fittings to an air supply, which may be an air hose. The air exit port 60 may be designed to accept standard or specialized fittings and may be connected by standard or specialized fittings to another air hose or directly to an air tool. The internal pressure port 50 of a mechanical air pressure gauge 14 may be connected to the air passage connecting the air entry 56 and exit ports 60. The external pressure vent 48 of a mechanical air pressure gauge 14 can be connected to the exterior of the housing 56. A single window 62 or multiple windows can be formed in the housing 56 for viewing a binary indicator relative to a fixed reference line 18 if the binary indicator is contained within the mechanical air pressure gauge or for viewing an indicator that moves relative to a fixed binary indicator. The window 62 can be any suitable shape including curved so that it can be viewed at many angles as shown in FIG. 5.

The gauges discussed above are not limited to the described shapes or configurations. For example, the gauge could be square, oval, or any other suitable shape. Other materials may also be utilized in constructing the gauge, the invention not being limited to the described materials or configurations.

While various features of the claimed invention are presented above, it should be understood that the features may be used singly or in any combination thereof Therefore, the claimed invention is not to be limited to only the specific embodiments depicted herein.

Further, it should be understood that variations and modifications may occur to those skilled in the art to which the claimed invention pertains. The embodiments described herein are examples of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

1. An integrated air pressure monitoring system for a continuous flow air tool having a housing comprising a mechanical air pressure gauge coupled to a binary indicator, said mechanical air pressure gauge being configured to be positioned inside the housing of the continuous flow air tool.

2. The integrated air pressure monitoring system of claim 1 wherein said binary indicator provides a visual indication of whether air pressure is within an acceptable pressure range or is not within said acceptable pressure range.

3. The integrated air pressure monitoring system of claim 2 wherein air pressure within said acceptable range is indicated by a first color and air pressure outside said acceptable range is indicated by a second color.

4. The integrated air pressure monitoring system of claim 3 wherein said first color is green and said second color is red.

5. The integrated air pressure monitoring system of claim 3 further comprising indicia indicating whether the air pressure is above said acceptable pressure range or below said acceptable pressure range.

6. The integrated air pressure monitoring system of claim 5 wherein said indicia indicating that the air pressure is above said acceptable pressure range is the word “hi” and said indicia indicating that the air pressure is below said acceptable pressure range is the word “low”.

7. The integrated air pressure monitoring system of claim 1 wherein said binary indicator moves relative to a fixed reference.

8. The integrated air pressure monitoring system of claim 1 wherein said binary indicator is stationary and an indicator coupled to said mechanical pressure gauge moves relative to said binary indicator.

9. The integrated air pressure monitoring system of claim 1 wherein said mechanical air pressure gauge comprises a housing and a piston movable within said housing, said housing including a pressure inlet and a pressure outlet, and said piston being configured to move in response to input from said pressure inlet and said pressure outlet.

10. A continuous flow air tool comprising the integrated pressure monitoring system of claim 1, wherein the mechanical air pressure gauge is positioned in the housing of the continuous flow air tool.

11. The continuous flow air tool of claim 10 wherein said binary indicator provides a visual indication of whether air pressure is within an acceptable pressure range or is not within said acceptable pressure range.

12. The continuous flow air tool of claim 11 wherein air pressure within said acceptable range is indicated by a first color and air pressure outside said acceptable range is indicated by a second color.

13. The continuous flow air tool of claim 12 wherein said first color is green and said second color is red.

14. The continuous flow air tool of claim 12 further comprising indicia indicating whether the air pressure is above said acceptable pressure range or below said acceptable pressure range.

15. The continuous flow air tool of claim 14 wherein said indicia indicating that the air pressure is above said acceptable pressure range is the word “hi” and said indicia indicating that the air pressure is below said acceptable pressure range is the word “low”.

16. The continuous flow air tool of claim 10 wherein said continuous flow air tool has an air flow control mechanism and said air pressure monitoring system is configured to monitor the pressure before said air flow control mechanism.

17. The continuous flow air tool of claim 10 wherein said continuous flow air tool has an air flow control mechanism and said air pressure monitoring system is configured to monitor the pressure after said air flow control mechanism.

18. The integrated air pressure monitoring system of claim 10 wherein said binary indicator moves relative to a fixed reference.

19. The integrated air pressure monitoring system of claim 10 wherein said binary indicator is stationary and an indicator coupled to said mechanical pressure gauge moves relative to said binary indicator.

20. The integrated air pressure monitoring system of claim 10 wherein said mechanical air pressure gauge comprises a housing and a piston movable within said housing, said housing including a pressure inlet and a pressure outlet, and said piston being configured to move in response to input from said pressure inlet and said pressure outlet.

21. An air pressure monitoring system for attaching in series between an inlet of a continuous flow air tool and an air supply hose, said air pressure monitoring system comprising a mechanical air pressure gauge coupled to a binary indicator, wherein the mechanical air pressure gauge and binary indicator are configured to couple between a continuous flow air tool and an air supply hose.

22. The air pressure monitoring system of claim 21 wherein the binary indicator provides a visual indication of whether air pressure is within an acceptable pressure range or is not within said acceptable pressure range.

23. The air pressure monitoring system of claim 22 wherein air pressure within said acceptable pressure range is indicated by a first color and air pressure outside said acceptable pressure range is indicated by a second color.

24. The air pressure monitoring system of claim 23 wherein said first color is green and said second color is red.

25. The air pressure monitoring system of claim 23 further comprising indicia indicating whether the air pressure is above said acceptable pressure range or below said acceptable pressure range.

26. The air pressure monitoring system of claim 25 wherein said indicia indicating that the air pressure is above said acceptable pressure range is the word “hi” and said indicia indicating that the air pressure is below said acceptable pressure range is the word “low”.

27. The integrated air pressure monitoring system of claim 21 wherein said binary indicator moves relative to a fixed reference.

28. The integrated air pressure monitoring system of claim 21 wherein said binary indicator is stationary and an indicator coupled to said mechanical pressure gauge moves relative to said binary indicator.

29. The air pressure monitoring system of claim 21 wherein said mechanical air pressure gauge comprises a housing and a piston movable within said housing, said housing including a pressure inlet and a pressure outlet, and said piston being configured to move in response to input from said pressure inlet and said pressure outlet.
